(19) United States
(12) Patent Application Publication
(10) Pub. No.: US 2026/0334533 A1
(43) Pub. Date: Oct. 29, 2026

(54) ELECTRONIC CHARCOAL FOR HOOKAH

(71) Applicants: Matan David SHABTAY, Ma'ale Adumim (IL); Eran AVIAD, Ma'ale Adumim (IL)

(72) Inventors: Matan David SHABTAY, Ma'ale Adumim (IL); Eran AVIAD, Ma'ale Adumim (IL)

(21) Appl. No.: 19/111,459

(22) PCT Filed: Sep. 13, 2023
(86) PCT No.: PCT/IB2023/059077

§ 371 Date: Mar. 13, 2025

Related U.S. Application Data
(60) Provisional application No. 63/406,750, filed on Sep. 15, 2022.

(51) Int. Cl. A24F 1/30; A24F 40/46; A24F 40/51; A24F 40/57; H05B 1/02; H05B 3/00

(52) U.S. Cl. CPC A24F 1/30; A24F 40/46; A24F 40/51; A24F 40/57; H05B 1/0202; H05B 3/0019

(57) ABSTRACT

Portable heating devices for a hookah or waterpipe and a method of using the same, including: a housing adapted to house therein: an electrical or combustion fluid-based heating mechanism; an energy source for the heating mechanism; a temperature sensor adapted to sense a temperature inside the housing; a control unit operationally coupled to the heating mechanism and temperature sensor, the control unit adapted to control activation of the heating mechanism based on sensor data from the temperature sensor; and an activation switch adapted to activate the portable heating device.

### FIELD OF THE INVENTION

The present invention relates to a portable heating device, especially for a hookah/water pipe.

### BACKGROUND OF THE INVENTION

Hookahs are waterpipes that are used to smoke specially made tobacco mixtures that come in a wide variety of flavors. They usually work by passing charcoal-heated air through the tobacco mixture and ultimately through a water-filled chamber. A user then inhales the smoke through a tube and mouthpiece.

The combustion of charcoal used to heat hookah tobacco may pose additional health risks (beyond the hazardous and addictive chemicals released from the tobacco), since this combustion process produces dangerous substances such as carbon monoxide, metals, and other chemicals.

FIG. 1A is a prior art diagram of a hookah/water pipe 10. The hookah is comprised of the following elements:
A bowl 12 holds the tobacco or smoking preparation T.
A bowl stem 14 is the part of the stem that attaches to the bowl.
A coal tray 16 is a resting place for lit coals and also catches fallen ash.
A stem 18 connects the bowl, base, and hose together.
A hose 20 is a long flexible piece of hollow tubing.
A hose connector and hose port 22. The hose port is also called a hose adaptor and is the element where the hose is inserted. The hose connector is the part of the hose that connects into the hose port.
A stem heart 24 is the bulky section of the stem that connects to the base and includes the hose port and release valve.
A release/purge valve 26 releases smoke from the base when the hose is blown into. A ball bearing blocks air from being drawn through the valve while inhaling.
A downstem 28 is the part of the stem that is submersed in water.
A diffuser 30 breaks up bubbles for a quieter smoking session.
A base 32 holds the water.
A hose handle 34 is the mouthpiece of the hose.

FIG. 1B is a prior art depiction of a foil-covered hookah bowl. One method of heating up a hookah involves the use of a foil-covered bowl. This is also considered the traditional method. Aluminum foil 40 is tightly wrapped around the bowl and poked with plenty of small holes on top for airflow. Some foil products for the hookah come pre-poked. The charcoal 42 rests directly on top of the foil and the tobacco is placed inside the bowl.

FIG. 1C is a diagram indicating how a hookah works. The user inhales through the hose. The suction pulls air through the coals. The tobacco is heated and produces smoke. Smoke travels down the stem and passes through the water to cool down (and possibly filter some of the harmful chemicals). Smoke fills the base and is drawn out through the hose.

### SUMMARY OF THE INVENTION

According to the present invention there is provided a portable heating device for a hookah or waterpipe, including: a housing adapted to house therein: a heating mechanism; an energy source for the heating mechanism; a temperature sensor adapted to sense a temperature inside the housing; a control unit operationally coupled to the heating mechanism and temperature sensor, the control unit adapted to control activation of the heating mechanism based on sensor data from the temperature sensor; and an activation switch adapted to activate the portable heating device.

According to further features in preferred embodiments of the invention the heating mechanism is an electrical heating element. According to further features the energy source is a rechargeable power cell, such that when the power cell is charged, the portable heating device can be used without a connection to an external energy source. According to further features the power cell is a rechargeable battery that is adapted to be recharged by an electricity grid or a portable power bank or the power cell is a photovoltaic cell adapted to be recharged by solar energy.

According to further features the temperature sensor is selected from a group including: a thermocouple, a Resistance Temperature Detector (RTD), a thermistor, and a semiconductor based integrated circuit.

According to further features the housing further includes vents adapted to allow excess heat to escape. According to further features the housing has a top surface, a bottom surface and a side wall, and wherein the bottom surface includes an opening for a heat transfer element for transferring heat from the heating mechanism to a target object.

According to further features the target object is a smoking preparation such as a smoking preparation that includes tobacco ingredients. According to further features the target object includes tobacco ingredients covered in foil.

According to further features the control unit is configured to instruct an actuator to activate the heating mechanism until the temperature sensor senses that a first predetermined temperature threshold has been reached at which time the control unit instructs the actuator to deactivate the heating mechanism until the temperature sensors senses that a second predetermined temperature threshold has been reached at which time the control unit instructs the actuator to reactivate the heating mechanism; wherein the first temperature threshold is higher than the second temperature threshold.

According to another embodiment there is provided a portable heating device for a hookah, including: a housing adapted to house therein: a heating mechanism; an energy source for the heating mechanism, the energy source including a combustible fluid reservoir and an ignition device; a temperature sensor adapted to sense a temperature inside the housing; a control unit operationally coupled to the heating mechanism, the energy source, and the temperature sensor, the control unit adapted to control activation of the heating mechanism based on sensor data from the temperature sensor; and an activation switch to activating the portable heating device.

According to further features the heating mechanism is a mechanism for burning combustible fluid. According to further features the heating mechanism is a gas burner.

According to further features the combustible fluid reservoir is a replaceable or refillable gas cartridge such that when the reservoir is filled, the portable heating device can be used without a connection to an external energy source. According to further features the gas cartridge includes a fragrance that is adapted to be dispensed with fluid in the gas cartridge.

According to further features the ignition device is an electrical lighter.

According to further features the control unit is configured to instruct a valve of the reservoir to open and to activate the ignition device to ignite the combustible fluid, the valve remains open until a first predefined temperature threshold is reached, at which time the control unit instructions the valve to close until a second predefined temperature threshold is reached, at which time the control unit instruct the valve to reopen and activates the ignition device; and wherein the first temperature threshold is higher than the second temperature threshold.

According to another embodiment there is provided a method for preparing and smoking a hookah or water pipe, the method including the steps of: filling a hookah bowl with a smoking preparation; placing an electrical or combustible fluid-based portable heating device on top of the smoking preparation in the hookah bowl; activating the heating device; and inhaling smoke via a hose of the hookah or water pipe, wherein the hose is in fluid communication with the smoking preparation.

According to further features the portable heating device is rechargeable or refillable.

### BRIEF DESCRIPTION OF THE DRAWINGS

Various embodiments are herein described, by way of example only, with reference to the accompanying drawings, wherein:

FIGS. 1A-1C are depictions of prior art hookah type water pipes;

FIGS. 2A-2E are various view of an example embodiment of the portable heating device of the invention;

FIG. 3 is a cross-sectional view of an example of an electric powered embodiment of the heating device;

FIG. 4 is a cross-sectional view of an example, gas burner portable heating device 300 for a hookah/waterpipe; and

FIG. 5 is a flow diagram depicting a method 500 for preparing and smoking a hookah or water pipe.

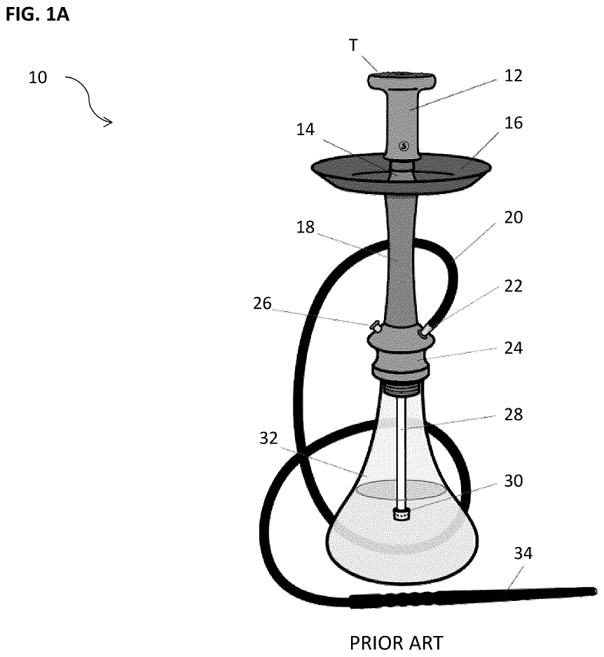

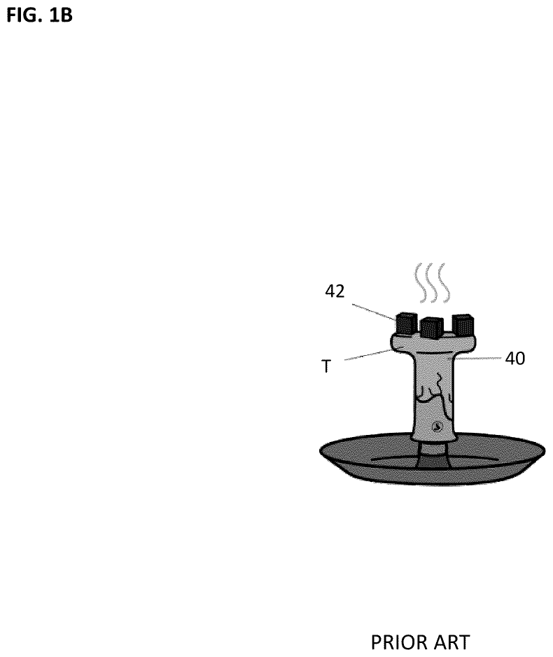

### DESCRIPTION OF THE PREFERRED EMBODIMENTS

The principles and operation of an electric heating mechanism according to the present invention may be better understood with reference to the drawings and the accompanying description.

The terms “hookah” and “water pipe”, “waterpipe”, and variations thereof are used interchangeably herein and are intended, for the purposes of this document, to refer to any type of smoking apparatus that is based on a smoking a smoking preparation that is heated and passed through fluid, such as water, before being inhaled by a user.

Using coal for the purposes of smoking is very unhealthy as coal and its smoke is toxic. Burning coal impinges on the quality of the environment and generates air pollution. In general, burning coal is an environmental polluter.

The present invention is directed to a device that serves as a unit of energy and high heat generation to burn the tobacco in the hookah, without the need for additional burning coals. In preferred embodiments, the product is adapted to use disposable and/or rechargeable energy source such as an electric battery and/or gas. In embodiments, the device uses electric, gas, and/or solar energy.

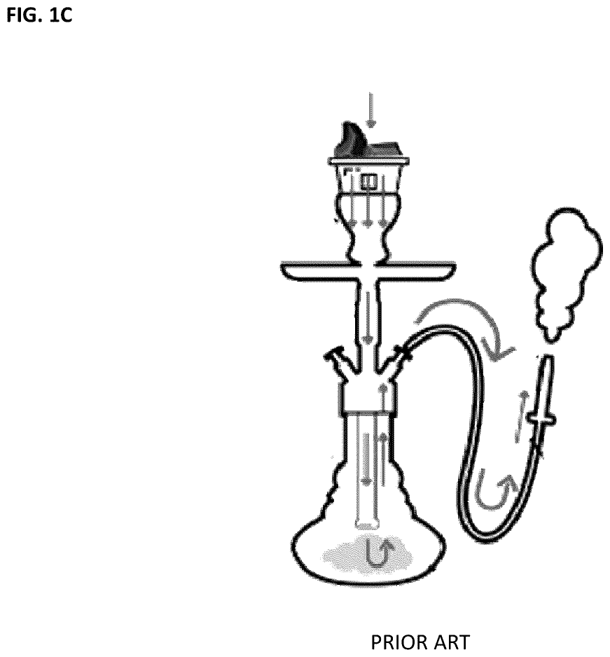

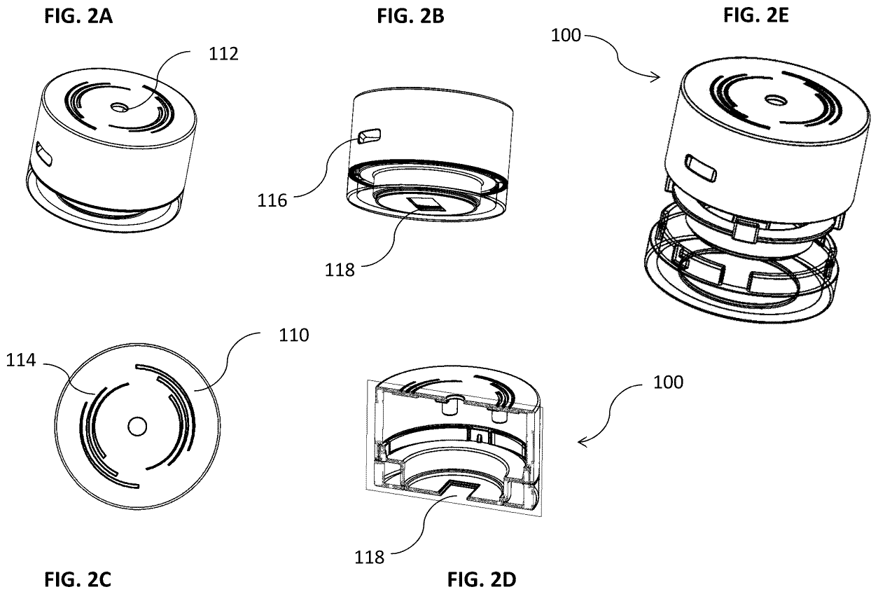

FIGS. 2A-2E illustrate various views of an example embodiment of the heating device according to the present invention. FIG. 2A is an isometric top view of the device, with a bottom portion rendered transparent. FIG. 2B is an isometric bottom view of the device, with the bottom portion rendered transparent. FIG. 2C is a top-down view of the device. FIG. 2D is an isometric sectional view of the device. 2E is an exploded view of the device 100.

With reference to FIGS. 2A to 2E, the same components are referenced using the same numbers. Device 100 includes a shell or housing 110 with a number of openings formed in the shell. A top opening 112 is for an on/off button. Vents 114 allow excess heat to dissipate. A side opening 116 is adapted to receive a gas refill cartridge or a USB power cord, depending on the type of energy source in the device. The bottom opening 118 is the heating portal through which heat generated inside the device is channeled out of the housing 110, to heat the tobacco.

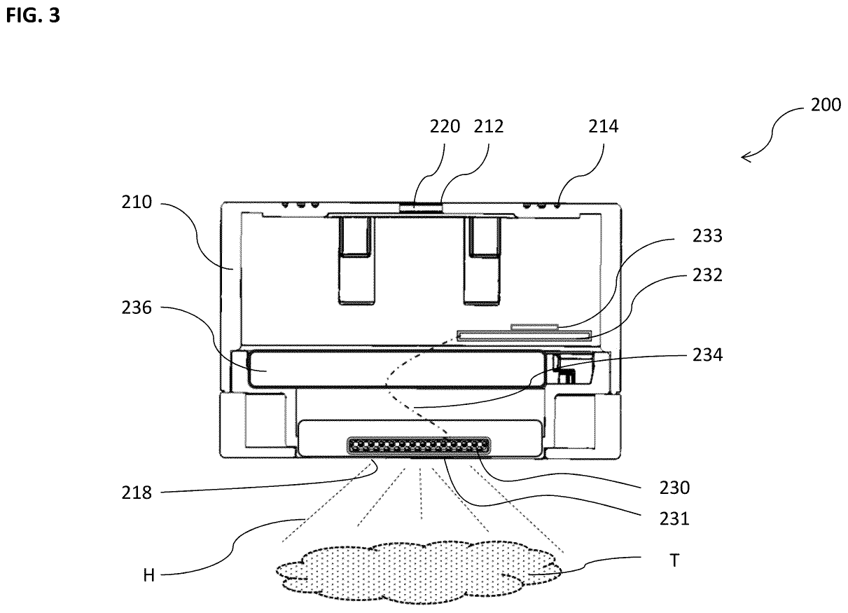

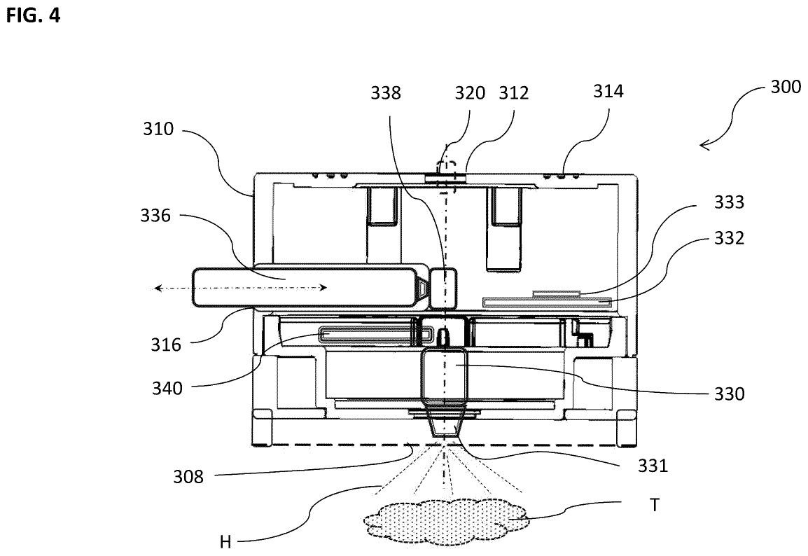

FIG. 3 is a cross-sectional view of an example of an electric powered embodiment of the heating device. For the sake of clarity, each embodiment will be separately numbered but will follow a convention: The example embodiment in FIGS. 2A-2D is labeled device 100. The electric powered embodiment in FIG. 3 is labeled device 200 and the gas-powered embodiment in FIG. 4 is labeled device 300. For each of the depicted embodiments 100, 200, 300, the same components will be indicated with the same numbers following the 1, 2, or 3 which indicate the embodiment number. So, for example, the housing of device 100 is labeled housing 110, while the same housing in device 200 is labeled housing 210, and in device 300, housing 310. Same or similar components are correspondingly labeled (as described heretofore) and any component that is described with reference to one embodiment is to be seen as being described for all of the embodiments, mutatis mutandis, where the same or similar component is found.

Housing 210 has a top surface, a bottom surface, and a sidewall. The housing may include more than one shell portion. For example, the top surface and sidewall may be formed from a single piece and the bottom surface may be a separate shell piece. Housing 210 includes vents 214, top opening 212 for an on/off button 220, and a bottom opening 218, through which heat H is channeled, to heat tobacco T. Device 200 is an electric-powered heating mechanism. Device 200 can be used, for example, for heating tobacco (or a tobacco or other smoking preparation) in a hookah/water pipe. The device includes a heating element 230, located above the bottom opening 218. The operation of the heating element, once it is turned on by button 220, is controlled by a control unit, e.g., a control unit embedded on a chip 232. The chip is operationally coupled to the heating element 230 and temperature sensor 233, for example, via a wired connector 234.

Any applicable option for electronic chip 232 may be used to control the heating element 230. The chip 232 may have a temperature sensor 233 embedded thereon or may be operationally coupled to a separate temperature sensor. Examples of temperature sensors include, but are not limited to: Thermocouples, Resistance Temperature Detectors (RTDs), thermistors, and semiconductor based integrated circuits. Many examples of electronic chips are known in the art. Two example options are discussed hereafter.

An application-specific integrated circuit (ASIC) is an integrated circuit (IC) chip customized for a particular use, rather than intended for general-purpose use, such as a chip designed to run in a digital voice recorder or a high-efficiency video codec, or, in this case, a temperature-controlled heating element. ASIC chips are typically fabricated using metal-oxide-semiconductor (MOS) technology, as MOS integrated circuit chips.

ASICs often include entire microprocessors, memory blocks including ROM, RAM, EEPROM, flash memory and other large building blocks. Such an ASIC is often termed a SoC (system-on-chip).

Field-programmable gate arrays (FPGA) are the modern-day technology improvement on breadboards, meaning that they are not made to be application-specific as opposed to ASICs. Programmable logic blocks and programmable interconnects allow the same FPGA to be used in many different applications. The control unit may be an ASIC, an FPGA, or any other relevant mechanism known in the art.

Device 200 includes a power or energy source. In the example embodiment, the energy source is a power cell 236, such as a battery and/or a photovoltaic cell. Battery 236 may be replaceable and/or rechargeable. A rechargeable battery may be charged via a cable to an electrical outlet (electricity grid) and/or a power bank (e.g., a portable charger, a desktop or laptop battery, etc.), e.g., via a USB charger cord. Alternatively, or additionally, the power cell may be charged via solar means (not shown).

The device is switched on and off by a power button. An example on/off switch 220 activates and deactivates the portable heating device 200. The control unit 232 is operationally coupled to the heating mechanism 230 and temperature sensor 233. The control unit is adapted to control activation of the heating mechanism based on sensor data from the temperature sensor. For example, control unit is configured to instruct an actuator to activate the heating mechanism until the temperature sensor senses that a first predetermined temperature threshold has been reached at which time the control unit instructs the actuator to deactivate the heating mechanism until the temperature sensor senses that a second predetermined temperature threshold has been reached at which time the control unit instructs the actuator to reactivate the heating mechanism. In the example embodiment, the first temperature threshold is higher than the second temperature threshold.

The bottom surface includes an opening 218 for a heat transfer element 231 for transferring heat from the heating mechanism to a target object. The heat transfer element may be a metal plate or grill coupled to the heating element 230. The heating mechanism may include any type of relevant heating element known in the art.

A heating element is a component composed of both electrically conductive as well as insulating material, designed to serve a heating purpose. The fundamental core of an electric heater is the heating element alloy within that turns electrical energy into heat energy when subjected to a current. It is the part of a heater where the electrical load occurs. When heat is produced in this way it is called Resistive Heating. It is also known as Joule Heating.

Electrically conductive heating element wire exists within a framework of electrically insulating material. The wire may be corrugated, coiled or straight Examples of heating elements include, but are not limited to: flex heaters, silicone rubber heaters, polyimide heaters, thick film heaters, PTC heaters, cartridge heaters, strip heaters, and tubular heaters.

Flexible heaters (also known as flex heaters) are surface heaters that can be bent to conform to the surface being heated. They can be shaped during manufacturing to fit complex geometries. Flexible heaters contain thin film, foil, or wire wound heating elements manufactured from a wide variety of alloys.

Silicone rubber heaters contain one or more heating elements sandwiched within two pieces of vulcanized silicone rubber. The rubber is electrically insulating yet thermally conductive. The elements within are thin foil alloys that have been etched. Polyimide heaters are similar to silicone rubber heaters in that they are thin flat etched heating elements. They are lighter in weight than silicone and bend more easily.

Thick Film Heaters are low-profile (thin) heaters that are manufactured with precision equipment to produce two-dimensional geometries in a wide variety of wattages and voltages. Ideally suited for applications that require rapid response and temperature uniformity. The thin profile is well suited where space is limited. These heaters can achieve very high temperatures.

PTC Heaters (Positive Temperature Coefficient Heaters) contain trace amounts of an electrically conductive material such as carbon black mixed with an electrically insulating yet thermally conductive material such as silicone rubber. Two leads buried within this material do not physically touch. The ratio of electrically conductive vs electrically insulating material is carefully controlled during manufacturing.

A cartridge heater contains an electric coil surrounded by an insulating powder (typically magnesium oxide) and packed within a tapered sheath. All terminals exit the same end.

A strip heater is a relatively flat rectangular heater made from a strip of mica that has been wrapped with ribbon wire. That assembly is sandwiched between two more pieces of mica and then encased in a metal sheath. If you bend a strip heater into the shape of a ring, then you have a band heater. They are clamped around pipes, barrels, and the base of kettles. They are used to heat fluids and to assist in the melting of solids.

Tubular heaters have an electric coil surrounded by a ceramic insulating powder encased within a metal sheath.

Another possible configuration is shown in FIG. 4. FIG. 4 is a cross-sectional view of an example, gas burner portable heating device 300 for a hookah/waterpipe. Device 300 includes a housing 310 and an on/off switch 320. Housing 310 has a top surface, a bottom surface, and a sidewall. The housing may include more than one shell portion. For example, the top surface and sidewall may be formed from a single piece and the bottom surface may be a separate shell piece. Housing 310 includes vents 314, top opening 312 for on/off button 320, and a bottom opening 308, through which heat H is channeled, to heat tobacco T.

Device 300 is a portable heating device that uses combustible fluid. Device 300 can be used, for example, for heating tobacco (or a tobacco or other smoking preparation) in a hookah/water pipe. The device includes a heating mechanism 330. The operation of the heating mechanism, once the device is turned on by a button 320, is controlled by a control unit, e.g., a control unit embedded on a chip 332. Chip 332 is similar to chip 232 detailed above. Those details apply similarly to chip 332 and should be seen as repeated fully herein, mutatis mutandis. The chip is operationally coupled to the heating mechanism 330 and a temperature sensor 333. Temperature sensor 333 is the same or similar to temperature sensor 233 detailed above. Those details apply similarly to temperature sensor 333 and should be seen as repeated fully herein, mutatis mutandis.

Heating mechanism 330, in the example embodiment depicted in FIG. 4, is a gas burner. The energy source for the gas burner includes a combustible fluid reservoir and an ignition device. In the example embodiment depicted in FIG. 4, the reservoir is a gas cartridge 336. In embodiments, the cartridge is replaceable and/or refillable, such that when the reservoir is filled, the portable heating device can be used without a connection to an external energy source. The cartridge may be inserted through an opening 316 in the side wall of the housing.

The lighter mechanism in the example embodiment is an electric lighter 340. The electric lighter may be powered by a battery. The lighter mechanism and/or the reservoir may include a servo-mechanism for opening and closing a valve of the reservoir/gas cartridge. In embodiments, the servo-mechanism is integrated into the reservoir (e.g., the gas cartridge) and in communication with the control unit. In embodiments, the servo-mechanism is separate from the reservoir/gas cartridge and is adapted to open and close the valve of the reservoir/cartridge. The servo-mechanism being in electrical communication with the control unit (e.g., embedded on chip 333). The valve of the reservoir/cartridge may unbiased, being controlled by the servo-mechanism. The valve of the reservoir/cartridge may be biased closed (for example, the valve may be spring-loaded). In such a case, the servo-mechanism controls opening of the valve by forcing the valve against the biasing mechanism and controls closing the valve by releasing the pressure on the biasing mechanism and allow the biasing mechanism to close the valve.

The gas burner 330 has, for example, a turbo burner head 331. The heating mechanism includes a gas coupling 338 to which the gas (or other combustible fluid) cartridge 336 couples and through which gas passes when the valve of the gas cartridge is open. The servo-mechanism for controlling the valve of the reservoir (e.g., gas cartridge) may be housed in the gas coupling 338. Accordingly, reference 338 can be applied to the servo-mechanism as well as to the gas coupling. The housing has a porous bottom surface 308, e.g., a grate, through which heat H from the flame emanates.

The control unit is configured to instruct the cartridge to expel the fluid and the electrical lighter to ignite the fluid. The cartridge expels fluid (e.g., having a valve controlled by a servo mechanism as above) to heat the tobacco/smoking preparation until the temperature sensor senses that a first predetermined temperature threshold has been reached at which time the control unit instructs the servo-controlled valve to close, deactivating the heating mechanism until the temperature sensor senses that a second predetermined temperature threshold has been reached at which time the control unit instructs that the valve be opened and the electrical lighter is instructed to ignite the fluid. The first temperature threshold is higher than the second temperature threshold.

In some embodiments, the gas cartridge includes a scent, fragrance, or perfume that is released with the gas and adds a fragrant scent to the hookah smoking experience.

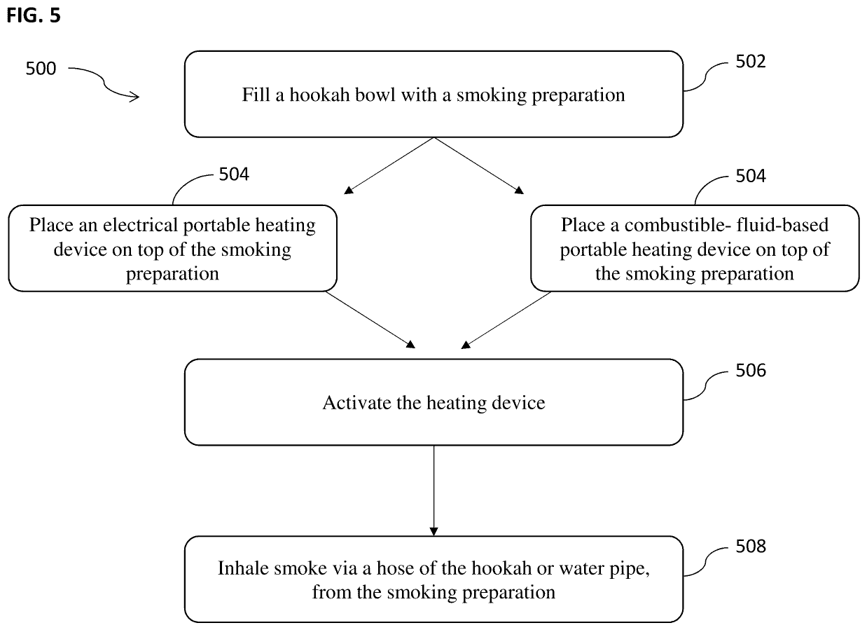

FIG. 5 is a flow diagram depicting a method 500 for preparing and smoking a hookah or water pipe.
Step 502 includes filling a hookah bowl with a smoking preparation;
Step 504 includes placing a portable heating device of on top of the hookah bowl. The portable heating device may be an electronic heating device, similar to device 200 or a combustible fluid-based heating device, similar to device 300.
Step 506 includes activating the heating device.
Step 508 includes inhaling smoke via a hose of the hookah or water pipe, wherein the hose is in fluid communication with the smoking preparation.

In embodiments, the portable heating device is rechargeable or refillable.

Implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system.

As used herein, the singular form “a”, “an” and “the” include plural references unless the context clearly dictates otherwise.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination or as suitable in any other described embodiment of the invention. Certain features described in the context of various embodiments are not to be considered essential features of those embodiments, unless the embodiment is inoperative without those elements.

In the discussion, unless otherwise stated, adjectives such as “substantially” and “about” that modify a condition or relationship characteristic of a feature or features of an embodiment of the invention, are to be understood to mean that the condition or characteristic is defined to within tolerances that are acceptable for operation of the embodiment for an application for which it is intended.

Positional terms such as “upper”, “lower” “right”, “left”, “bottom”, “below”, “lowered”, “low”, “top”, “above”, “elevated”, “high”, “vertical” and “horizontal” as well as grammatical variations thereof as may be used herein do not necessarily indicate that, for example, a “bottom” component is below a “top” component, or that a component that is “below” is indeed “below” another component or that a component that is “above” is indeed “above” another component as such directions, components or both may be flipped, rotated, moved in space, placed in a diagonal orientation or position, placed horizontally or vertically, or similarly modified. Accordingly, it will be appreciated that the terms “bottom”, “below”, “top” and “above” may be used herein for exemplary purposes only, to illustrate the relative positioning or placement of certain components, to indicate a first and a second component or to do both.

“Coupled with” means indirectly or directly “coupled with”.

Where applicable, although state diagrams, flow diagrams or both may be used to describe embodiments, the technique is not limited to those diagrams or to the corresponding descriptions. For example, flow need not move through each illustrated box or state, or in exactly the same order as illustrated and described.

It should be understood that where the claims or specification refer to “a” or “an” element, such reference is not to be construed as there being only one of that element.

In the description and claims of the present application, each of the verbs, “comprise” “include” and “have”, and conjugates thereof, are used to indicate that the object or objects of the verb are not necessarily a complete listing of components, elements or parts of the subject or subjects of the verb.

Unless otherwise stated, the use of the expression “and/or” between the last two members of a list of options for selection indicates that a selection of one or more of the listed options is appropriate and may be made.

While the invention has been described with respect to a limited number of embodiments, it will be appreciated that many variations, modifications and other applications of the invention may be made. Therefore, the claimed invention as recited in the claims that follow is not limited to the embodiments described herein.

1. A portable heating device for a hookah or waterpipe, comprising:
a housing adapted to house therein:
a heating mechanism;
an energy source for the heating mechanism;
a temperature sensor adapted to sense a temperature inside the housing;
a control unit operationally coupled to the heating mechanism and temperature sensor, the control unit adapted to control activation of the heating mechanism based on sensor data from the temperature sensor; and
an activation switch adapted to activate the portable heating device.

2. The device of claim 1, wherein the heating mechanism is an electrical heating element.

3. The device of claim 1, wherein the energy source is a rechargeable power cell, such that when the power cell is charged, the portable heating device can be used without a connection to an external energy source.

4. The device of claim 3, wherein the power cell is a rechargeable battery that is adapted to be recharged by an electricity grid or a portable power bank; or wherein the power cell is a photovoltaic cell.

5. The device of claim 1, wherein the temperature sensor is selected from a group including: a thermocouple, a Resistance Temperature Detector (RTD), a thermistor, and a semiconductor based integrated circuit.

6. The device of claim 1, wherein the housing further includes vents adapted to allow excess heat to escape.

7. The device of claim 1, wherein the housing has a top surface, a bottom surface and a side wall, and wherein the bottom surface includes an opening for a heat transfer element for transferring heat from the heating mechanism to a target object.

8. The device of claim 7, wherein the target object includes tobacco ingredients.

9. The device of claim 7, wherein the target object includes tobacco ingredients covered in foil.

10. The device of claim 1, wherein the control unit is configured to instruct an actuator to activate the heating mechanism until the temperature sensor senses that a first predetermined temperature threshold has been reached at which time the control unit instructs the actuator to deactivate the heating mechanism until the temperature sensors senses that a second predetermined temperature threshold has been reached at which time the control unit instructs the actuator to reactivate the heating mechanism;
wherein the first temperature threshold is higher than the second temperature threshold.

11. A portable heating device for a hookah, comprising:
a housing adapted to house therein:
a heating mechanism;
an energy source for the heating mechanism, the energy source including a combustible fluid reservoir and an ignition device;
a temperature sensor adapted to sense a temperature inside the housing;
a control unit operationally coupled to the heating mechanism, the energy source, and the temperature sensor, the control unit adapted to control activation of the heating mechanism based on sensor data from the temperature sensor; and
an activation switch to activating the portable heating device.

12. The device of claim 11, wherein the heating mechanism is a mechanism for burning combustible fluid.

13. The device of claim 12, wherein the heating mechanism is a gas burner.

14. The device of claim 11, wherein the combustible fluid reservoir is a replaceable or refillable gas cartridge such that when the reservoir is filled, the portable heating device can be used without a connection to an external energy source.

15. The device of claim 14, wherein the gas cartridge includes a fragrance that is adapted to be dispensed with fluid in the gas cartridge.

16. The device of claim 11, wherein the ignition device is an electrical lighter.

17. The device of claim 11, the control unit is configured to instruct a valve of the reservoir to open and to activate the ignition device to ignite the combustible fluid, the valve remains open until a first predefined temperature threshold is reached, at which time the control unit instructions the valve to close until a second predefined temperature threshold is reached, at which time the control unit instruct the valve to reopen and activates the ignition device; and
wherein the first temperature threshold is higher than the second temperature threshold.

18. A method for preparing and smoking a hookah or water pipe, the method comprising the steps of:
filling a hookah bowl with a smoking preparation;
placing a portable heating device of claim 1 on top of the smoking preparation in the hookah bowl;
activating the heating device; and
inhaling smoke via a hose of the hookah or water pipe, wherein the hose is in fluid communication with the smoking preparation.

19. The method of claim 18, wherein the portable heating device is rechargeable or refillable.

20. A method for preparing and smoking a hookah or water pipe, the method comprising the steps of:
filling a hookah bowl with a smoking preparation;
placing a portable heating device of claim 11 on top of the smoking preparation in the hookah bowl;
activating the heating device; and
inhaling smoke via a hose of the hookah or water pipe, wherein the hose is in fluid communication with the smoking preparation.
